(19) United States
(12) Patent Application Publication
(10) Pub. No.: US 2013/0293690 A1
(43) Pub. Date: Nov. 7, 2013

(54) Medical device navigation system stereoscopic display

(71) Applicant: Eric S. Olson, Maplewood, MN (US)

(72) Inventor: Eric S. Olson, Maplewood, MN (US)

(21) Appl. No.: 13/783,619

(22) Filed: Mar. 4, 2013

Related U.S. Application Data
(60) Provisional application No. 61/643,667, filed on May 7, 2012.

(51) Int. Cl. H04N 13/04

(52) U.S. Cl. CPC H04N 13/0438
USPC 348/56

(57) ABSTRACT

A system for displaying a stereoscopic representation of a modeled object such as an anatomical model can include an electronic control unit (ECU), a computer-readable memory coupled to the ECU, display logic, a synchronization circuit, and stereoscopic eyewear. The system can show a stereoscopic view of the anatomical model according to active stereoscopy. Thus, the display logic can be configured to render at least two views of the anatomical model and to provide the at least two views in a sequence for output to a display. The synchronization circuit can be configured to synchronize the sequence of the at least two views with the operation of the stereoscopic eyewear. The at least two views can be displayed according to a viewing position of a user.

### CROSS REFERENCE TO RELATED APPLICATION

This application claims the benefit of U.S. provisional application No. 61/643,667, filed 7 May 2012, entitled “Medical Device Navigation System Stereoscopic Display,” which is hereby expressly incorporated by reference as though fully set forth herein.

### BACKGROUND OF THE INVENTION

a. Field of the Invention

The instant disclosure relates to user interfaces for medical device mapping and navigation systems. More specifically, the instant disclosure relates to two-dimensional, three-dimensional, and stereoscopic displays of anatomical models and medical devices in a mapping and navigation system.

b. Background Art

It is known to use a medical device mapping and navigation system to map anatomical structures, to display maps, models, and images of those anatomical structures, and to guide one or more medical devices to and through those anatomical structures. In one known type of mapping and navigation system, anatomical maps and models can be rendered in three dimensions, but projected onto a traditional two-dimensional (2D) display. As a physician guides a catheter to and through the mapped or modeled anatomy, the mapping and navigation system can determine the position of one or more portions of the catheter and superimpose a representation of the catheter on the map or model on the 2D display.

Images and projections of maps, models, and catheter representations on traditional 2D displays are inherently limited in their ability to illustrate depth, even if the underlying mage is rendered in three dimensions. With a traditional 2D display, it is very difficult to show the depth of various anatomical features (i.e., “into” or “out of” the plane of the display screen), and also very difficult to show the depth of an elongate medical device, such as, for example, a catheter, relative to those features. Accordingly, with only a 2D display, the view must be rotated and shifted a number of times during a procedure to guide a catheter to its intended destination, which can extend the time required for an electrophysiology procedure.

One known solution for providing the depth of anatomical features and catheters on a 2D display is to provide two views, with the second view orthogonal or at a different viewing angle to the first. However, such solutions are not without their disadvantages. For example, with two views, the three-dimensional position and orientation of the catheter can generally be seen by a physician, but the physician must maintain constant awareness of both views. Although the views may be provided adjacent to each other, looking back and forth between the views may still require more time than if a single view were provided that allowed the physician to observe depth without a second view and without manually rotating or shifting the view. Also, the use of two two-dimensional views to provide the physician with a three-dimensional understanding is not intuitive, and in some cases, may require the physician to repeatedly view and analyze the two images back and forth.

The foregoing discussion is intended only to illustrate the present field and should not be taken as a disavowal of claim scope.

### BRIEF SUMMARY OF THE INVENTION

In various embodiments and to address one or more of the disadvantages set forth above, an electrophysiology (EP) lab can be provided with a system, such as a mapping and navigation system, that provides stereoscopic visualization of an anatomical model, a superimposed medical device as well as other augmented objects such as labels, markers, and/or other graphical representations. One embodiment of such a system can include an electronic control unit (ECU), a computer-readable memory coupled to the ECU, and display logic. The display logic can be stored in the memory and configured to be executed by the ECU, and can be configured to render at least two views of the anatomical model and to provide the at least two views for output to a display for a user to view as a stereoscopic image with each view targeted to a particular eye of the user. In an embodiment, the system can also include a synchronization circuit configured to synchronize the sequence of the at least two views with the operation of stereoscopic eyewear. In an embodiment, the system can further include stereoscopic eyewear configured to receive a signal generated by the synchronization circuit and to alter a user's field of vision according to the signal.

Another embodiment of a system for displaying a stereoscopic representation of an anatomical model can include an ECU, computer-readable memory coupled to the ECU, an imaging apparatus, and display logic, stored in the memory and configured to be executed by the ECU. In an embodiment, the imaging apparatus can be configured to capture an image for determining a user's viewing position, and the display logic can be configured to render at least two views of an anatomical model according to the viewing position and to provide the at least two views for output to a display for the user to view as a stereoscopic image. In an embodiment, the display logic can be configured to render the at least two views of the anatomical model according to the viewing position by altering a first view frustum for a first of the at least two views and altering a second view frustum for a second of the at least two views. In an embodiment, the imaging apparatus can be configured to capture the image in the visible light spectrum. Additionally or alternatively, the imaging apparatus can be configured to capture the image in the infrared (IR) spectrum. In an embodiment, the system can further include positioning logic, stored in the memory and configured to be executed by the ECU, configured to determine the viewing position of the user by determining a position of one or more of the user's head, the user's eyes, one or more infrared emitters, and one or more infrared reflectors in the image.

Another embodiment of a system for displaying a stereoscopic representation of an anatomical model can include an ECU, a computer-readable memory coupled to the ECU, an imaging apparatus, and display logic and device control logic stored in the memory and configured to be executed by the ECU. In an embodiment, the imaging apparatus can be configured to capture an image for determining a user's viewing position, and the display logic can be configured to render at least two views of an anatomical model and to provide the at least two views for output to a display for the user to view as a stereoscopic image. The device control logic can be configured to alter the operation of one or more devices when the viewing position indicates that the user is not viewing the display. In an embodiment, the device control logic can be configured to instruct the display logic to provide at least one view for output to the display for the user to view as a two dimensional image or three-dimensional projection when the viewing position indicates that the user is not viewing the display. In an embodiment, the device control logic can be configured to output a signal configured to prevent a user's field of vision from being obstructed when the viewing position indicates that the user is not viewing the display.

### BRIEF DESCRIPTION OF THE DRAWINGS

FIG. 1 is a schematic and block diagram view of a medical device mapping and navigation system.

FIGS. 2A-2D are schematic diagrams of exemplary dipole pairs of driven body surface electrodes.

FIG. 3 is a schematic and block diagram view of a system for displaying a stereoscopic view of a modeled object such as an anatomical model.

FIGS. 4A and 4B are diagrammatic illustrations of stereoscopic views of a cardiac model on a display.

### DETAILED DESCRIPTION OF THE INVENTION

Various embodiments are described herein to various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment,” or the like, means that a particular feature, structure, or characteristic described in connection with the embodiment is included in at least one embodiment. Thus, appearances of the phrases “in various embodiments,” “in some embodiments,” “in one embodiment,” or “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

It will be appreciated that the terms “proximal” and “distal” may be used throughout the specification with reference to a clinician manipulating one end of an instrument used to treat a patient. The term “proximal” refers to the portion of the instrument closest to the clinician and the term “distal” refers to the portion located furthest from the clinician. It will be further appreciated that for conciseness and clarity, spatial terms such as “vertical,” “horizontal,” “up,” and “down” may be used herein with respect to the illustrated embodiments. However, surgical instruments may be used in many orientations and positions, and these terms are not intended to be limiting and absolute.

Various types of images, views, and projections are discussed herein. “Stereoscopic” images or views refer to, as will be further explained below, an image or view that the user perceives as a three-dimensional image, allowing a user to perceive depth, in space. The stereoscopic image or view may be constructed by a combination of hardware and software techniques, as will be described. In contrast, “two-dimensional (2D)-rendered” and “three-dimensional (3D)-rendered” views and images refer to views, images, and projections on a traditional two-dimensional (2D) display, intended to be viewed within the plane of the 2D display. 2D and 3D-rendered views and images may also be referred to as “traditional” views and images. In addition, as used herein the terms “object” or “augmented object” are used to denote one or multiple anatomical models, maps, medical device representations, labels, markers, projections, and/or other graphical representations that can be visualized on a display panel, graphical user interface, or the like.

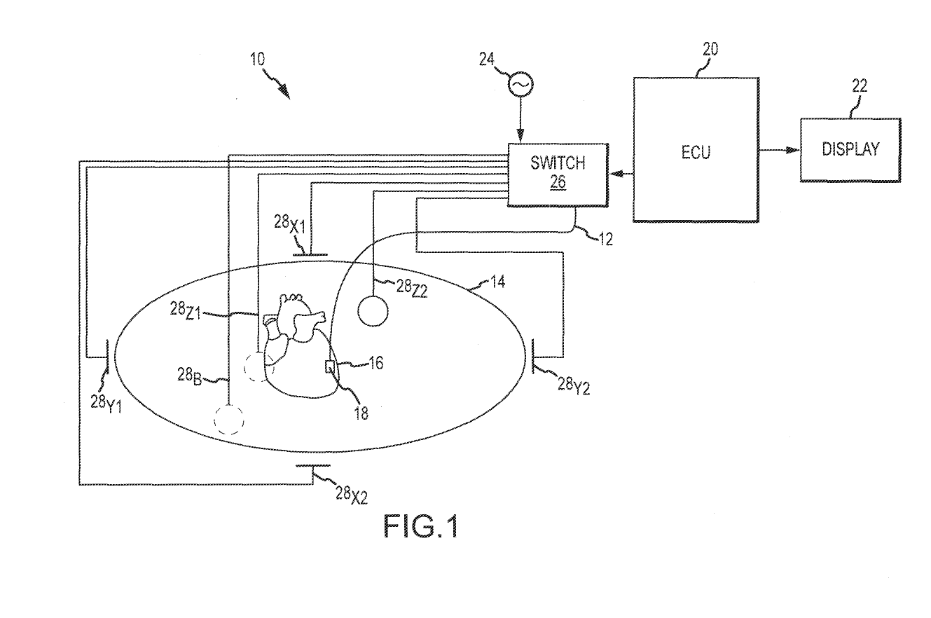

Referring now to the Figures, in which like reference numerals refer to the same or similar features in the various views, FIG. 1 is a schematic and diagrammatic view of an embodiment of a medical device mapping and navigation system 10. The system 10 can be coupled with an elongate medical device such as, for example only, a catheter that can be guided to and disposed in a portion of a body 14, such as a heart 16. For purposes of clarity and illustration, the description below will be limited to an embodiment wherein the elongate medical device comprises a catheter (i.e., a catheter 12). The catheter 12 includes one or more sensors 18 for, e.g., determining a location within the heart 16. The system 10 includes an electronic control unit (ECU) 20, a display 22, a signal generator 24, a switch 26, and a plurality of body surface electrode patches 28.

The mapping and navigation system 10 is provided for visualization, mapping, and/or navigation of internal body structures and may be referred to herein as “the navigation system.” The navigation system 10 may comprise an electric field-based system, such as, for example, an ENSITE™ VELOCITY™ cardiac electro-anatomic mapping system running a version of ENSITE™ NAVX™ navigation and visualization technology software commercially available from St. Jude Medical, Inc., of St. Paul, Minn. and as also seen generally by reference to U.S. Pat. No. 7,263,397, or U.S. Patent Application Publication No. 2007/0060833 A1, both hereby incorporated by reference in their entireties as though fully set forth herein. In other exemplary embodiments, however, the navigation system 10 may comprise systems other than electric field-based systems. For example, the navigation system 10 may comprise a magnetic field-based system such as the Carto™ system commercially available from Biosense Webster, and as generally shown with reference to one or more of U.S. Pat. Nos. 6,498,944; 6,788,967; and 6,690,963, the disclosures of which are hereby incorporated by reference in their entireties as though fully set forth herein. In another exemplary embodiment, the navigation system 10 may comprise a magnetic field-based system such as the MEDIGUIDE™ Technology system available from St. Jude Medical, Inc., and as generally shown with reference to one or more of U.S. Pat. Nos. 6,233,476; 7,197,354; and 7,386,339, the disclosures of which are hereby incorporated by reference in their entireties as though fully set forth herein. In yet another embodiment, the navigation system 10 may comprise a combination electric field-based and magnetic field-based system, such as, for example and without limitation, the systems described in pending U.S. patent application Ser. No. 13/231,284 entitled “Catheter Navigation Using Impedance and Magnetic Field Measurements” filed on Sep. 13, 2011 and U.S. patent application Ser. No. 13/087,203 entitled “System and Method for Registration of Multiple Navigation Systems to a Common Coordinate Frame” filed on Apr. 14, 2011, each of which are hereby incorporated by reference in its entirety as though set fully forth herein, or the CARTO™ 3 system commercially available from Biosense Webster. In yet still other exemplary embodiments, the navigation system 10 may comprise or be used in conjunction with other commonly available systems, such as, for example and without limitation, fluoroscopic, computed tomography (CT), and magnetic resonance imaging (MRI)-based systems. For purposes of clarity and illustration only, the navigation system 10 will be described hereinafter as comprising an electric current-based system, such as, for example, the ENSITE™ VELOCITY™ system identified above.

In an embodiment, the system 10 may be used with a remote catheter guidance system, such as that described in U.S. Patent Application Publication No. 2010/0256558 and in PCT/US2009/038597, published as WO 2009/120982, the disclosures of which are hereby incorporated by reference in their entireties as though fully set forth herein.

With continued reference to FIG. 1, with the exception of the patch electrode 28_{B} called a “belly patch,” the patch electrodes 28 of the system 10 are provided to generate electrical signals used, for example, in determining the position and orientation of the catheter 12 and in the guidance thereof. In one embodiment, the patch electrodes 28 are placed generally orthogonally on the surface of the body 14 and are used to create axes-specific electric fields within the body 14. For instance, in one exemplary embodiment, patch electrodes 28_{X1}, 28_{X2} may be placed along a first (x) axis. Patch electrodes 28_{Y1}, 28_{Y2} may be placed along a second (y) axis, and patch electrodes 28_{Z1}, 28_{Z2} may be placed along a third (z) axis. Each of the patch electrodes 28 may be coupled to the multiplex switch 26. In an exemplary embodiment, the ECU 20 is configured, through appropriate software, to provide control signals to the multiplex switch 26 to thereby sequentially couple pairs of electrodes 28 to the signal generator 24. Excitation of each pair of electrodes 28 (e.g., in either orthogonal or non-orthogonal pairs) generates an electrical field within the patient's body 14 and within an area of interest such as the heart 16. Voltage levels at non-excited electrodes 28, which are referenced to the belly patch 28_{B}, are filtered and converted and provided to the ECU 20 for use as reference values.

As noted above, one or more electrodes 18 are mounted in or on the catheter 12. The sensors 18 (and the catheter 12 itself) may be provided for a variety of diagnostic and therapeutic purposes including, for example, electrophysiological studies, pacing, cardiac mapping, and ablation. In an embodiment, the catheter 12 can be an ablation catheter, mapping catheter, or other elongate medical device. The number, shape, orientation, and purpose of the sensors 18 may vary in accordance with the purpose of the catheter 12. In an exemplary embodiment, at least one of the electrodes comprises a positioning electrode and is configured to be electrically coupled to the ECU 20.

With a positioning electrode 18 electrically coupled to the ECU 20, the electrode 18 is placed within electrical fields created in the body 14 (e.g., within the heart 16) by exciting the patch electrodes 28. The positioning electrode 18 experiences voltages that are dependent on the position of the positioning electrode 18 relative to the locations of the patch electrodes 28. Voltage measurement comparisons made between the positioning electrode 18 and the patch electrodes 28 can be used to determine the position of the positioning electrode 18 relative to the heart 16 or other tissue. Movement of the positioning electrode 18 proximate a tissue (e.g., within a chamber of the heart 16) produces information regarding the geometry of the tissue. This information may be used, for example, to generate models and maps of anatomical structures. Information received from the positioning electrode 18 can also be used to display on a display device, such as display 22, the location and/or orientation of the positioning electrode 18 and/or the tip of the catheter 12 relative to a modeled object such as an anatomical model of the heart 16 or other tissue. Accordingly, among other things, the ECU 20 of the navigation system 10 provides a means for generating display signals used to control the display 22 and the creation of a graphical user interface (GUI) on the display 22.

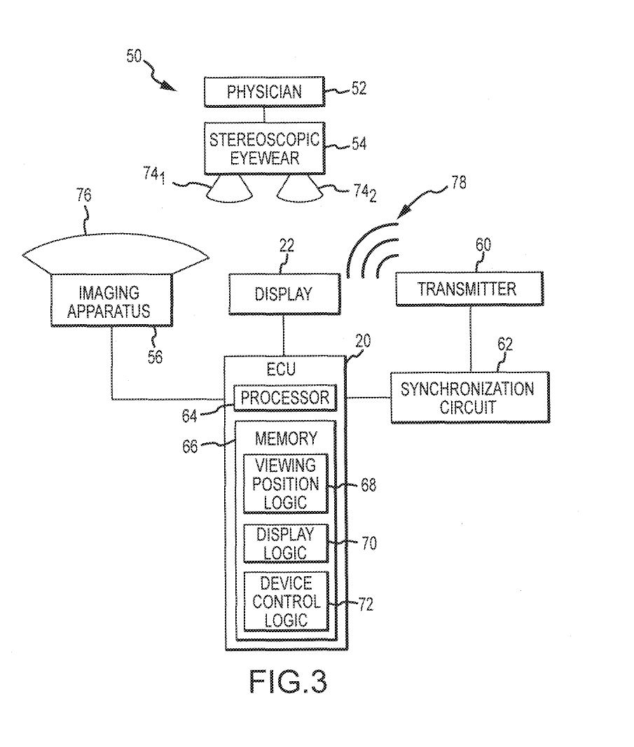

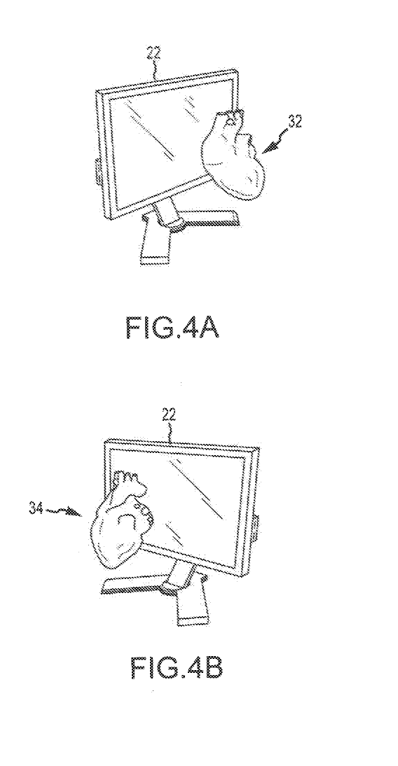

The ECU 20 may comprise a programmable microprocessor or microcontroller, or may comprise an application specific integrated circuit (ASIC). The ECU 20 may include a an input/output (I/O) interface through which the ECU 20 may receive a plurality of input signals including, for example, signals generated by patch electrodes 28 and the positioning electrode 18 (among others), and generate a plurality of output signals including, for example, those used to control the display 22 and other user interface components. The ECU 20 may be configured to perform various functions, such as those described in greater detail above and below, with appropriate programming instructions or code (i.e., software). Accordingly, the ECU 20 is programmed with one or more computer programs encoded on a computer-readable storage medium for performing the functionality described herein. For example, as will be described in conjunction with FIGS. 3-4B, the ECU 20 can be configured to execute display logic to display one or more projections, views, and/or images of an anatomical model on the display 22, viewing position logic to determine a viewing position of a user, and device control logic to alter the operation of one or more devices within the operating room or electrophysiology lab according to the viewing position of a user relative to the display 22.

In operation, as the patch electrodes 28 are selectively energized, the ECU 20 receives position signals (location information) from the catheter 12 (and particularly the positioning electrode 18) reflecting changes in voltage levels on the positioning electrode 18 and from the non-energized patch electrodes 28. The ECU 20 uses the raw positioning data produced by the patch electrodes 28 and positioning electrode 18 and corrects the data to account for respiration, cardiac activity, and other artifacts using known techniques. The corrected data may then be used by the ECU 20 in a number of ways, such as, for example and without limitation, to guide an ablation catheter to a treatment site, to create a model of an anatomical structure, to map electrophysiological data on an image or model of the heart 16 or other tissue, or to create a representation of the catheter 12 that may be superimposed on a map, model, or image of the heart 16 or other tissue. A representation of the catheter 12 may be superimposed on the map, model, or image of the heart 16 according to positioning information received from the sensors 18. In an embodiment, it may be advantageous to display a model of the heart 16 and a representation of the catheter 12 in 3D to provide a physician with a more accurate understanding of the position and orientation of the catheter 12 relative to surfaces and features of the heart 16.

Maps and models of the heart 16 and of other tissue may be constructed by the ECU 20, such as, for example only, as the result of a geometry collection with the catheter 12. Additionally or alternatively, the ECU 20 may import an image, map, or model from an external source, such as a CT, MRI, fluoroscopic, or other image or model. In addition, the ECU 20 can be configured to register such external maps and models with a map or model generated by the ECU 20 for overlaid or other simultaneous display.

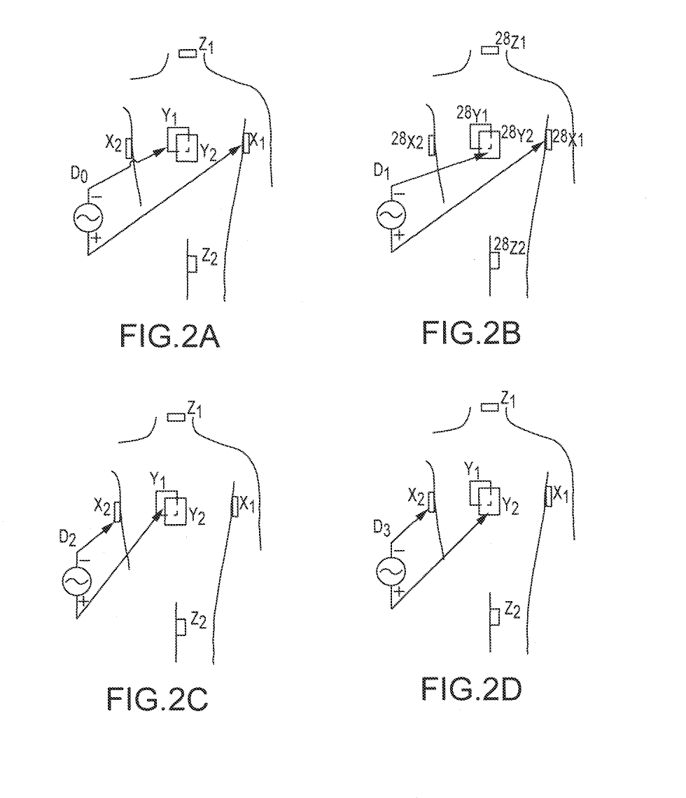

FIGS. 2A-2D show a plurality of exemplary non-orthogonal dipoles, designated D₀, D₁, D₂ and D₃. For any desired axis, the potentials measured across an intra-cardiac sensor 18 resulting from a predetermined set of drive (source-sink) configurations may be combined algebraically to yield the same effective potential as would be obtained by simply driving a uniform current along the orthogonal axes. Any two of the surface electrodes 28 may be selected as a dipole source and drain with respect to a ground reference, e.g., belly patch 28_{B}, while the unexcited body surface electrodes measure voltage with respect to the ground reference. The sensor 18 placed in heart 16 is also exposed to the field from a current pulse and is measured with respect to ground, e.g., belly patch 28_{B}. In practice, a catheter or multiple catheters within the heart may contain multiple sensors and each sensor potential may be measured separately.

Data sets from each of the surface electrodes and the internal electrodes are all used to determine the location of measurement electrode 18 within heart 16. After the voltage measurements are made, a different pair of surface electrodes is excited by the current source and the voltage measurement process of the remaining patch electrodes and internal electrodes takes place. The sequence occurs rapidly, e.g., on the order of 100 times per second in an embodiment. To a first approximation the voltage on the electrodes within the heart bears a linear relationship with position between the patch electrodes that establish the field within the heart, as more fully described in U.S. Pat. No. 7,263,397 referred to above.

In summary, FIG. 1 shows an exemplary navigation system 10 that employs seven body surface electrodes (patches), which may be used for injecting current and sensing resultant voltages. Current may be driven between two patches at any time; some of those driven currents are illustrated in FIGS. 2A-2D. Measurements may be performed between a non-driven patch and, for example, belly patch 28_{B} as a ground reference. A patch bio-impedance, also referred to as a “patch impedance” may be computed according to the following equation:

$$BioZ [ c \to d ] [ e ] = \frac{{V}_{e}}{{I}_{c \to d}} \qquad ( 1 )$$

where Vₑ is the voltage measured on patch e and I_{c→d} is a known constant current driven between patches c and d. The position of an electrode may be determined by driving current between different sets of patches and measuring one or more patch impedances. In one embodiment, time division multiplexing may be used to drive and measure all quantities of interest. Position determining procedures are described in more detail in U.S. Pat. No. 7,263,397 and Publication 2007/0060833 referred to above, as well as other references.

As noted above, in at least one embodiment, it may be advantageous to display a stereoscopic image or view of an anatomical model to aid a physician's understanding of the relative positions of anatomical structures and other objects, such as a catheter. In some embodiments, for example, a stereoscopic image or view of an object such as an anatomical model of the heart can be used as an aid in performing diagnostic and/or therapeutic procedures on a patient. In some embodiments, a stereoscopic image or view of an object can be generated from images acquired from a 3D imaging device such as, for example, a 3D intracardiac echocardiography (ICE) catheter, a 3D endoscopic imaging probe, or an optical coherence tomography (OCT) probe. Other objects such as medical device representations, labels, and/or markers can also be displayed as part of the stereoscopic image or view along with the anatomical model. In some embodiments, the stereoscopic image or view of the object can also be obtained from a 3D imaging modality such as rotational angiography or 3D CT or MRI. One system for displaying a stereoscopic view or image of an object such as anatomical model can include a display capable of displaying a stereoscopic image and stereoscopic eyewear, worn by the physician, for converting the stereoscopic image shown by the display into a coherent image for the physician.

FIG. 3 is a schematic and block diagram view of an embodiment of a system 50 for displaying a stereoscopic view of a modeled object (e.g., an anatomical model) for a user, such as a physician 52. The system includes stereoscopic eyewear 54 to be worn by the physician 52, an imaging apparatus 56 for capturing an image of the physician's viewing position, the display 22, a transmitter 60, a synchronization circuit 62, and the ECU 20. The ECU 20 can include a processor 64, memory 66, and viewing position logic 68, display logic 70, and device control logic 72 stored in the memory 66.

The display 22 and stereoscopic eyewear 54 operate in conjunction with each other so that the physician 52, when using the stereoscopic eyewear 54, perceives a stereoscopic view displayed by the display 22. The stereoscopic rendering technique can be one of many stereoscopic techniques known in the art, such as, for example only, active stereoscopy, passive stereoscopy, or autostereoscopy (which may not require stereoscopic eyewear 54). The system 50 will be described generally with reference to active stereoscopy, but the system 50 is not so limited.

In active stereoscopy, a display rapidly switches between an image for the right eye (e.g., a 3D-rendered image of the subject model from a first point-of-view) and an image for the left eye (e.g., a 3D-rendered image of the subject model from a second point-of-view). The stereoscopic eyewear 54, in turn, is configured to obstruct the viewer's right eye while the left eye image is shown on the display 22, and to obstruct the viewer's left eye when the right eye image is shown on the display 22. If this sequence is rapid enough, the viewer will “see” the rapidly switching images as a single stereoscopic image in space. The stereoscopic image may appear to the viewer to be entirely or partially in front of and/or behind the display 22. In general, the image switching should be at about 100-120 frames per second (i.e., 50-60 frames per second for each eye) for a successful stereoscopic effect.

In an embodiment, the display 22 is configured for active stereoscopy. The display 22 may have a high enough refresh rate and response time for switching between right-eye and left-eye images to create a stereoscopic effect. Displays for active stereoscopy are generally known in the art. In an embodiment, the display 22 can be a 3D Series display commercially available from Acer, Inc. of Taiwan.

More than one display 22 can be provided in the system 50. For example, one display can be provided for, e.g., stereoscopic views of an anatomical model, and another display may be provided for, e.g., traditional 2D and 3D-rendered images of the anatomical model, such that a stereoscopic view and a traditional 2D or 3D-rendered view are available throughout a medical procedure. In an embodiment, a single display 22 may provide both 2D and 3D-rendered views and stereoscopic views, either alternately or concurrently.

The stereoscopic eyewear 54 can also be configured for active stereoscopy. Accordingly, the stereoscopic eyewear 54 can include two or more lenses for alternately obstructing the fields of view 74₁, 74₂ of the right and left eyes of the physician 52. The stereoscopic eyewear 54 can also include a receiver for receiving a synchronization signal and a processor for processing the synchronization signal so that the stereoscopic eyewear 54 obstructs the field of view 74 of the proper eye at the proper time in sync with the image switching of the display 22.

In an embodiment, the stereoscopic eyewear 54 may include liquid crystal shutter lenses for obstructing the field of view 74 of a user. Liquid crystal shutter lenses are, in general, opaque when a voltage is applied, and transparent when a voltage is not applied. Thus, the stereoscopic eyewear 54 may also include circuitry for applying a voltage across a left eye lens and/or a right eye lens. The stereoscopic eyewear 54 can be a stock or modified pair of one of the known liquid crystal shutter glasses, such as, for example only, the eyewear included with the 3D VISION™ Wireless Glasses Kit commercially available from Nvidia Corp of Santa Clara, Calif.

The transmitter 60 and the synchronization circuit 62 are provided for synchronizing the stereoscopic eyewear 54 with the display 22. The transmitter 60 may broadcast a signal 78 such as, for example, an RF signal or an infrared signal, for the stereoscopic eyewear 54. The signal can instruct the stereoscopic eyewear 54 when to obstruct which eye's field of view 74. The synchronization circuit 62 can be coupled with the ECU 20 for determining when the ECU 20 provides a right-eye view to the display 22 and when the ECU 20 provides a left-eye view for the display 22. The synchronization circuit 62 can thus provide a synchronization signal for the transmitter 60 to broadcast.

Both the synchronization circuit 62 and the transmitter 60 can include devices known in the art. For example, the transmitter 60 can be the transmitter included with the 3D VISION™ Wireless Glasses Kit commercially available from Nvidia Corp. of Santa Clara, Calif.

In an embodiment, the synchronization circuit 62 can be electrically coupled with a graphics card in the ECU 20. Although shown as separate from the ECU 20, the synchronization circuit 62 can be included in the ECU 20. In such an embodiment, the transmitter 60 may connect directly to the ECU 20. The synchronization circuit 62 can be, for example only, a Stereo Connector for QUADRO™ 3800/4000 commercially available from PNY Technologies Inc. of Parsippany, N.J.

The stereoscopic eyewear 54 may also include features customized for an electrophysiology lab environment. For example, the stereoscopic eyewear 54 may include two lens layers (e.g., two pairs of lenses)—one lens layer for stereoscopic obstruction, and the other for radiation protection. In an embodiment, the protective lens layer can comprise leaded glass. In addition, the protective lens layer may be only for protection, or may be both for protection and vision enhancement. For example, the protective lens layer can comprise prescription lenses to enhance vision for a particular physician. The stereoscopic eyewear 54 may thus be configured for the protective lens layer to be inserted, secured, and removed.

The stereoscopic eyewear 54 may also, in an embodiment, include one or more tags that can be tracked in space for determining the viewing position of the physician. For example, the stereoscopic eyewear 54 can include a number of infrared reflectors or emitters arranged in a pattern such that an image of the stereoscopic eyewear 54 taken with an infrared imaging apparatus (discussed below) is indicative of the position and orientation of the stereoscopic eyewear 54. In an embodiment, three infrared reflectors or emitters can be arranged in a triangular pattern on or around a nose bridge of the stereoscopic eyewear 54.

The ECU 20 can be configured to, in addition to the functions noted in conjunction with FIG. 1, provide one or more views or projections of an anatomical model to the display 22. The views provided by the ECU 20 can be 2D or 3D-rendered images and/or stereoscopic views or images. As noted above, the stereoscopic effect provided can be achieved by methods known in the art, such as, for example and without limitation, active stereoscopy, passive stereoscopy, and autostereoscopy. In an active stereoscopy embodiment, and as described above, the ECU 20 can be configured to provide alternate views of an anatomical model and/or a model of a medical device, such as a catheter, for a user's left and right eyes, and to rapidly alternate between those views. Accordingly, the ECU 20 can include a video card capable of active stereoscopic output. For example only, a video card in the ECU 20 can be an NVIDIA QUADRO™ FX 3800, commercially available from PNY Technologies Inc. of Parsippany, N.J.

It may be desirable to alter the operation of the display 22, the stereoscopic eyewear 54, and/or other devices in an EP lab according to what the physician 52 is looking at. In an embodiment, the system 50 can be configured to automatically determine what the physician 52 is looking at according to a viewing position of the physician 52. The viewing position can be determined by, for example only, tracking the position and orientation of one or more of the physician's head, the physician's eyes, and the stereoscopic eyewear 54. Other position tracking techniques can be used for tracking the physician's viewing position such as, for example, camera face/eye tracking techniques, magnetic tracking techniques, and/or audible tracking techniques (e.g., using audible churps).

The imaging apparatus 56 is provided for capturing one or more images of the physician 52 and/or the stereoscopic eyewear 54 within a field of view 76 for determining the viewing position of the physician 52. The imaging apparatus 56 can be configured for capturing one or more images under the control of the ECU 20, and providing the one or more images to the ECU 20 for processing.

The nature of the images captured by the imaging apparatus 56 (e.g., infrared, visible light spectrum, etc.) can be chosen for a particular application of the system 50. In an embodiment, the imaging apparatus 56 can include an infrared receiver configured to detect infrared radiation, such as infrared radiation from infrared emitters on the stereoscopic eyewear 54, for example. The imaging apparatus 56 may also be provided with one or more infrared emitters, with the imaging apparatus detecting reflections from infrared reflectors, such as infrared reflectors on the stereoscopic eyewear 54, for example. The imaging apparatus 56 can additionally or alternatively comprise a camera for capturing images in the visible light spectrum. Such a camera may be used, for example, for detecting the position and/or viewing direction of the head or eyes of the physician 52.

The ECU 20 can be provided with viewing position logic 68 for determining a viewing position of the physician. The determination can be made according to one or more images provided by the imaging apparatus 56. The viewing position logic 68 can be configured to process the one or more images to determine whether the physician 52 is looking at the display 22, for example. This information can be used by the ECU 20 for various functions, as further described below.

The viewing position logic 68 can be configured to detect the position of one or more of the physician's head, the physician's eyes, and the stereoscopic eyewear 54 using facial tracking, eye tracking, triangulation, and other techniques known in the art. For example, in an embodiment, the viewing position logic 68 can be configured for eye tracking. The viewing position logic 68 can apply any of the known eye tracking techniques known in the art such as, for example only, a corneal reflection-based technique with infrared or visible light. In the same or another embodiment, the viewing position logic 68 can be configured for head tracking by tracking one or more facial features, such as the corners of the mouth, for example only, as known in the art. The viewing position logic 68 can compare the detected position to a known positional relationship between the imaging apparatus 56 and the display 22 to determine if the physician 52 is looking at the display 22.

The ECU 20 can also be provided with display logic 70 to provide the GUI on the display 22. The GUI provided can include, among other things, one or more views of an anatomical model, a catheter representation, and buttons, sliders and other input mechanisms for interacting with the displayed model. The display logic 70 can be configured to provide one or more 2D or 3D-rendered and stereoscopic views of an anatomical model and/or medical device representation for display as part of the GUI. The display logic 70 can also be configured to alter the views of the model according to user input (e.g., zoom, rotate, translate).

To create a stereoscopic view for the physician 52, the display logic 70 may provide two different views of the anatomical model and/or other modeled objects for the physician's left eye and right eye, respectively. The views may be made different from each other by using different view frustums (i.e., virtual points of view) for the two views. The view frustum may be altered between the two views by changing the near, far, and side planes of the model view according to methods known in the art. Some software packages include the ability to generate correct view frustums for stereoscopic imaging, such as, for example only, OPENGL™.

In an embodiment, the display logic 70 can select a view frustum for each view according to a viewing position of the physician 52. By doing so, the stereoscopic effect provided by the display logic 70 can mimic how real-world objects are perceived. For example, the view frustums may be more different between the left eye and right eye when the physician 52 is close to the display 22, and less different when the physician 52 is farther away from the display 22. Additionally, the view frustum for each eye can be altered according to the horizontal and/or vertical position of the physician's viewing position relative to the display 22, so that the physician can look “around” the displayed model(s) by moving his or her head from side to side or up and down.

FIGS. 4A and 4B are diagrammatic depictions of alternate stereoscopic views 32, 34 of an anatomical model that may be provided by the display logic 70 on the display 22 according to a viewing position of the physician. As illustrated in FIG. 4A, a view 32 of a first side of the heart may be provided when the physician 52 views the display 22 from one angle. As illustrated in FIG. 4B, a view 34 of another side of the heart may be provided when the physician 52 views the display 22 from another angle. This view change can be provided by altering the view frustums. Significantly, this view frustum change can be provided simply by the physician 52 changing his or her viewing position, without instructing the ECU 20 to rotate the model itself. In other words, the physician 52 may move his or her head and/or eyes from one side of the model to the other and the view frustums may be appropriately adjusted so that the physician may see around various features of the model(s).

Although the views 32, 34 shown in FIGS. 4A and 4B are illustrated as to the front side of the display 22, this is for purposes of illustration only. In an actual stereoscopic image, the view would remain within the lateral and vertical thresholds of the display 22.

In an embodiment, the relationship between movement of the physician's viewing position and “movement” (i.e., altering of the view frustums) of the displayed stereoscopic view can be adjusted to the physician's preferences. For example, the display logic 70 can be configured to alter the view frustums a large amount for a relatively small horizontal or vertical movement by the physician, such that the physician can obtain significantly different views of the model and the position of a catheter with relatively small head movements. In another embodiment, the display logic 70 may be configured alter the view frustums very little for normal head movements of the physician, such that the physician can view a more stable 3D representation of the model and catheter relative to the model. This relationship can be configured, for example and without limitation, through the GUI provided by the display logic 70.

Referring again to FIG. 3, the ECU 20 can further be provided with device control logic 72 for altering the operation of one or more devices according to a viewing position of the physician 52. The device control logic 72 can be configured, for example, to disable the stereoscopic eyewear 54 when the physician 52 is not looking at the display 22 so that both lenses of the stereoscopic eyewear 54 remain transparent. Accordingly, the physician 52 can observe other objects in the EP lab or operating room without having his or her field of view 74 obstructed by the lenses of the stereoscopic eyewear 54. The device control logic 72 may disable the stereoscopic eyewear 54 by, for example, altering or disabling the synchronization signal from the synchronization circuit 62 and the transmitter 60.

The device control logic 72 can also be configured to instruct the display logic 70 to provide a particular view or views on the display 22 according to the viewing position of the physician 52. When a determined viewing position indicates that the physician 52 is looking at the display 22, the device control logic 72 can instruct the display logic 70 to provide a stereoscopic view on the display 22 for the physician's benefit. When a determined viewing position indicates that the physician 52 is not looking at the display 22, the device control logic 72 can instruct the display logic 70 to provide a traditional 2D or 3D-rendered view of the anatomical model on the display 22 for the benefit of those looking at the display 22 who do not have stereoscopic eyewear. This feature can be particularly advantageous in an active stereoscopy embodiment, since the rapidly switching views can be difficult to perceive without the specialized stereoscopic eyewear 54.

In operation, the system 50 can provide an environment for the physician 52 to view a stereoscopic view of an anatomical model and superimposed representation of a catheter while navigating the catheter 12 to a target site and performing one or more diagnostic or therapeutic operations at the target site. The physician 52 can wear the stereoscopic eyewear 54 during the procedure to enable stereoscopic visualization. When the physician 52 looks at the display 22, the display 22 can display a stereoscopic view for the physician 52. The views displayed (i.e., the view frustums) can change as the viewing position of the physician 52 changes. When the physician 52 looks away from the display 22, the display 22 can display a traditional 2D or 3D-rendered image, and the stereoscopic eyewear 54 can be disabled for the physician 52 to have an unobstructed view of other objects.

Although a number of embodiments of this invention have been described above with a certain degree of particularity, those skilled in the art could make numerous alterations to the disclosed embodiments without departing from the spirit or scope of this invention. All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A system for displaying a stereoscopic representation of an anatomical model, the system comprising:
an electronic control unit (ECU);
a computer-readable memory coupled to said ECU; and
display logic, stored in said memory and configured to be executed by said ECU, configured to render at least two views of the anatomical model and to provide said at least two views for output to a display for a user to view as a stereoscopic image, wherein each view is targeted to a particular eye of the user.

2. The system of claim 1, wherein the system further comprises:
stereoscopic eyeware; and
a synchronization circuit configured to synchronize the sequence of said at least two views with the operation of the stereoscopic eyewear.

3. The system of claim 2, wherein the stereoscopic eyewear is configured to receive a signal generated by said synchronization circuit and to alter the user's field of vision according to said signal.

4. The system of claim 3, wherein said stereoscopic eyewear is configured to alter the user's field of vision by obstructing one eye of the user during one portion of said sequence and obstructing the other eye of the user during another portion of said sequence.

5. The system of claim 4, wherein said stereoscopic eyewear comprises two liquid crystal lenses, each configured to selectively switch between a transparent state and an opaque state.

6. The system of claim 3, wherein said stereoscopic eyewear comprises a first lens layer for selectively obstructing the user's field of vision and a second lens layer configured to shield the user's eyes from radiation.

7. The system of claim 6, wherein said second lens layer is configured to be selectively removed by the user.

8. The system of claim 6, wherein said second lens layer comprises prescription lenses configured to enhance the vision of the user.

9. The system of claim 2, further comprising a transmitter configured to wirelessly transmit a synchronization signal generated by said synchronization circuit.

10. The system of claim 1, wherein said display logic is further configured to render said at least two views according to a viewing position of a user determined according to a position of one or more of the user's head, the user's eyes, and stereoscopic eyewear.

11. The system of claim 1, wherein said display logic is further configured to render at least two views of a medical device.

12. The system of claim 11, wherein the medical device is a catheter.

13. The system of claim 1, wherein said anatomical model comprises a map of electrophysiologic data.

14. A system for displaying a stereoscopic representation of an anatomical model, comprising:
an electronic control unit (ECU);
a computer-readable memory coupled to said ECU;
an imaging apparatus configured to capture an image for determining a user's viewing position; and
display logic, stored in said memory and configured to be executed by sad ECU, configured to render at least two views of the anatomical model according to said viewing position and to provide said at least two views for output to a display for the user to view as a stereoscopic image.

15. The system of claim 14, wherein said imaging apparatus is configured to capture said image in the visible light spectrum.

16. The system of claim 14, further comprising positioning logic, stored in said memory and configured to be executed by said ECU, configured to determine said viewing position by determining a position of the user's head in said image.

17. The system of claim 14, further comprising positioning logic, stored in said memory and configured to be executed by said ECU, configured to determine said viewing position by determining a position of the user's eyes in said image.

18. The system of claim 14, wherein said imaging apparatus is configured to capture said image in the infrared (IR) spectrum.

19. The system of claim 18, further comprising positioning logic, stored in said memory and configured to be executed by said ECU, configured to determine said viewing position by determining a position of one or more IR reflectors coupled to an eyewear apparatus.

20. The system of claim 14, wherein said display logic is configured to render said at least two views of the anatomical object according to said viewing position by altering a first view frustum for a first of said at least two views and altering a second view frustum for a second of said at least two views.

21. A system for displaying a stereoscopic representation of an anatomical model, comprising:
an electronic control unit (ECU);
a computer-readable memory coupled to said ECU;
an imaging apparatus configured to capture an image for determining a user's viewing position;
display logic, stored in said memory and configured to be executed by sad ECU, configured to render at least two views of the anatomical model and to provide said at least two views for output to a display for the user to view as a stereoscopic image; and
device control logic, stored in said memory and configured to be executed by said ECU, configured to alter the operation of one or more devices when said viewing position indicates that the user is not viewing the display.

22. The system of claim 21, wherein said device control logic is configured to instruct said display logic to provide at least one view for output to the display for the user to view as a two-dimensional or three-dimensional rendered image when said viewing position indicates that the user is not viewing the display.

23. The system of claim 21, wherein said device control logic is configured to output a signal configured to prevent a user's field of vision from being obstructed when said viewing position indicates that the user is not viewing the display.

24. The system of claim 23, further comprising liquid crystal shutter glasses comprising two liquid crystal lenses, wherein said device control logic is configured to output a signal to cause both liquid crystal lenses to remain transparent when said viewing position indicates that the user is not viewing the display.
